(19) United States
(12) Patent Application Publication
(10) Pub. No.: US 2007/0052131 A1
(43) Pub. Date: Mar. 8, 2007

(54) Method of producing a weld-cut sealing/heat-shrinkable packaging film formed of a polyethylene terephthalate-based block copolymer polyester

(75) Inventors: Takashi Fujimaki, Kanagawa (JP); Yukio Kobayashi, Tokyo (JP); Takashi Nakamoto, Osaka (JP); Hiroshi Shibano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NAKAMOTO PACKS CO., LTD., Osaka (JP)

(21) Appl. No.: 10/572,674

(22) PCT Filed: Sep. 21, 2004
(86) PCT No.: PCT/JP04/13758

§ 371 Date: Aug. 30, 2006

(30) Foreign Application Priority Data
Sep. 22, 2003 (JP) 2003-368117

(51) Int. Cl. B29C 71/00

(52) U.S. Cl. 264/210.7; 264/235.8

(57) ABSTRACT

A PET-based polyester packaging film capable of weld-cut sealing and heat-shrinkage refers to a film obtained by biaxially orienting a material prepared through block copolymerization of a PET/PETG/polyester elastomer with an epoxy resin and a catalyst. This film eliminates the most serious weak points in physical properties of conventional PET films, and is useful for packaging of books, bottlesets, food containers, etc., for general packaging, packaging of industrial materials, and the like, and is further useful in the field of packing and packaging of daily commodities, civil engineering and construction members, electric and electronic members, and automobile vehicle members, etc. Moreover, this film can be produced through effective use of the huge amount of recycled PET bottles and inexpensive PET for fiber as a prepolymer, and thus is also highly beneficial socially. Still further, even if incinerated after use, this film produces a combustion heat value lower than that of a polyethylene or polypropylene. Thus, this film barely damages incinerators or the like, and emits no toxic gases.

### TECHNICAL FIELD

The present invention relates to a method of producing a weld-cut sealing/heat-shrinkable packaging film formed of a polyethylene terephthalate (PET)-based block copolymer polyester which is suitable for heat-shrinkable film packaging applications.

### BACKGROUND ART

Polyvinyl chloride (PVC), polypropylene (PP), polystyrene (PS), polyethylene terephthalate (PET), a PETG (amorphous resin of an ethylene glycol/cyclohexane dimethanol/terephthalic acid condensate) laminate, or the like have been tried as material resin for heat sealing, weld-cut sealing film, or weld-cut sealing/heat-shrinkable film for packaging. However, these materials each have advantages and disadvantages in molding workability, quality, cost, environmental compatibility, and the like.

Recently, oriented polyethylene (PE stretch), oriented polystyrene (OPS), oriented PET, PETG, or the like instead of oriented polyvinyl chloride (PVC stretch) have rapidly been tried as material for heat-shrinkable film such as a solvent bonding heat-shrinkable labels for PET bottles. Numerous patents exist regarding PET- and PETG-based heat-shrinkable labels as a heat-shrinkable labels for PET bottles. However, the patents each relate to a method involving: synthesizing a PET- or PETG-based random copolymer polyester through a polycondensation method; extruding the polyester into a sheet through a casting method; and molding the obtained sheet into a uniaxially oriented film having thickness of about 25 to 75 μm (1 to 3 mil) through a transverse uniaxial orientation method.

Meanwhile, biaxially oriented polypropylene film (OPP, IOPP) or biaxially oriented polyolefin multilayer film (PO multilayer) have been tried as a weld-cut sealing/heat-shrinkable packaging material for food packaging of cupped food, dessert food, cartons, sweets, or the like, and for general packaging of book bindings, daily goods (AV, OA), or the like. However, no biaxially oriented PET-based polyester film having a thickness of about 25 μm or less (1 mil or less) has been hitherto developed. This PET-based polyester packaging material differs from polypropylene or polyolefin packaging material in that it adsorbs no food odor, has little air permeability, and has aroma retention and antioxidant properties. Thus, the PET-based polyester packaging material is expected to be more suitable as a food packaging material than polypropylene or polyolefin packaging material.

Recently, development of materials having excellent environmental compatibility is expected. For example, printing ink is shifting from oily solvent-based ink containing toluene or the like to water-based ink. For film material, hydrophilic PET and PETG are more preferable than oriented polystyrene (OPS), oriented polypropylene (OPP, IOPP), or oriented polyethylene (PE stretch) which are oily and difficult to use with water-based printing ink. The inventors of the present invention have developed a water-based printing ink and printing method adaptable to PET-based polyesters (Patent Document 1).

However, development of a weld-cut sealing/heat-shrinkable packing film formed of an inexpensive PET-based polyester and having excellent environmental compatibility has been expected to date.

Polyethylene terephthalate has high quality, and thus a large amount of polyethylene terephthalate is used for PET bottles through a stretch blowing method. Further, amorphous polyethylene terephthalate (A-PET) sheets have excellent transparency, rigidity, and environmental compatibility, and thus its use in commodity applications such as food packaging materials, food containers, IT materials, and blister packages is rapidly expanding. In particular, recovery and recycling of used PET bottles, films, sheets, and the like are strongly promoted, and large amounts thereof can be obtained at low cost, that is, at half the price of a general-purpose resin.

The inventors of the present invention have completed a heat sealing film laminate containing a heat sealing film and a base substance by: providing a resin having increased molecular weight and increased melt strength which is produced by using as main components recovered PET bottle flakes and recovered PET sheets available at half the price of a general-purpose resin, or PET for fiber obtained at low cost through a polycondensation method and reacting this with an epoxy-based binder and a coupling reaction catalyst; and molding said resin into an unoriented film through an extrusion lamination method as seen in (Patent Document 2). However, the inventors of the present invention had no ideas regarding weld-cut sealing film or weld-cut sealing/heat-shrinkable film. In any case, neither conventional commercially available biaxially oriented PET film nor unoriented A-PET film prepared through a casting method have heat-shrinkage properties, sufficient heat sealing strength or weld-cut sealing strength for practical use.
Patent Document 1: Japanese Patent Application No. 2003-182777
Patent Document 2: Japanese Patent Application No. 2002-360003

### DISCLOSURE OF THE INVENTION

[Problems to be Solved by the Invention]

An object of the present invention is to provide a method of producing an inexpensive, heat-shrinkable, and heat resistant weld-cut sealing packaging film formed of a PET-based block copolymer polyester.

A conventional biaxially oriented PET film is produced by: orienting and crystallizing through a biaxial orientation method a low molecular weight PET resin (intrinsic viscosity: about 0.6 to 0.7 dl/g) obtained through a polycondensation method; and heat setting the resin. Further, unoriented film (A-PET film) recently used as an alternative for polyvinyl chloride sheet is produced through a casting method from relatively expensive PET resin (intrinsic viscosity: about 0.8 dl/g) converted into a middle molecular weight substance through a solid phase polymerization method. Further, expensive PET resin (intrinsic viscosity: about 0.8 to 1.2) converted into a high molecular weight substance through a solid phase polymerization method has a linear structure and a relatively low melt strength. Thus, the PET resin is liable to be crystallized and is difficult to mold into a film. The commercially available biaxially oriented PET film and unoriented A-PET film both have no heat sealing properties, weld-cut sealing properties, or heat-shrinkage properties that are intended in the present invention, or have insufficient heat sealing properties, weld-cut sealing properties, and heat-shrinkage properties for practical use.

Thus, an object of the present invention is: to modify recovered PET bottle flakes and recovered PET sheet crushed products available at half the price of a general-purpose resin, or virgin pellets for fiber available at low cost through a polycondensation method as main raw materials and other transparent resins as auxiliary materials, with an epoxy-based binder and a coupling reaction catalyst; and to improve the weld-cut sealing properties and heat-shrinkage properties of the film.

[Means for Solving the Problems]

The inventors of the present invention have conducted extensive studies for attaining the above-mentioned objects. As a result, the inventors have succeeded in attaining the above-mentioned objects and have completed the present invention. That is, inexpensive recovered PET or PET for fiber was employed as a main raw material for a film, and PETG and a polyester elastomer were employed as auxiliary materials. The raw materials were subjected to molecular weight increase, melt strength increase, and block copolymerization through a reactive extrusion method or reaction vessel method employing a binder and a catalyst, or masterbatches thereof, to thereby obtain at high speed a resin or pellets having significantly reduced formation of gel/fish eye as a by-product. The inventors of the present invention have found that a weld-cut sealing/heat-shrinkable packaging film formed of a PET-based block copolymer polyester can be produced from the obtained pellets through a biaxial orientation method or a tubular method.

The method of the present invention basically involves: subjecting an aromatic terminal carboxylic acid of a PET resin, PETG, or a polyester elastomer to a coupling reaction with an epoxy resin as a binder in the presence of a catalyst; and forming a polyhydroxy ester bond inside a quaternary block copolymer. Note that a raw material such as PET having hydroxy groups on both terminals does not undergo the coupling reaction. A “long chain branched structure” is introduced into PET as a main raw material by using a compound (bifunctional: D) having two epoxy groups and a compound (trifunctional: T, tetra-or more functional: P) having three or more epoxy groups. Increase in T/D ratio increases crystallization rate and presumably allows development of heat sealing properties. That is, a reaction product (having a di-, tri-, or polyhydroxy ester bond) of the compound having two or more epoxy groups coordinates to an alkali metal, alkali earth metal, or other metal as a catalyst, to thereby presumably act as a “crystallization nucleator at a molecular size level”. Further, a residue of the epoxy resin is introduced into the PET resin. Thus, a composition of the PET resin of the present invention and commercially available PET resin form a “polycrystalline material”, and develops heat sealing property and weld-cut sealing properties.

PETG as an auxiliary material acts as an amorphous component having no melting point, allows orientation molding of a block copolymer film at low temperatures, and contributes to improvement in degree of heat-shrinkage at low temperatures.

A polyester elastomer as an auxiliary material similarly improves orientation molding property at low temperatures, improves weld-cut sealing strength, and contributes to softening of the film.

The PET-based block copolymer polyester of the present invention having the “long chain branched structure” may have a melt viscosity increased about 10 to 100 times that of conventional PET having a “linear structure” by an “entanglement effect” of molecular chains. Thus, the PET-based block copolymer polyester may be subjected to molding of a biaxially oriented film through a tubular method, which was not possible with the conventional PET.

That is, the present invention provides the following items.

First, there is provided a method of producing a weld-cut sealing/heat-shrinkable packaging film formed of a PET-based block copolymer polyester, characterized by involving:

melting at a temperature at or above its melting point a mixture “A” composed of:

(1) 100 parts by weight of a polyethylene terephthalate (PET)-based polyester “a” having a melt flow rate (MFR, JIS method: 280° C., load of 2.16 Kg) of 45 to 130 g/10 minutes as a main raw material;

(2) 0 to 100 parts by weight of an ethylene glycol/cyclohexane dimethanol/phthalic acid copolyester “b” as an auxiliary material;

(3) 0 to 20 parts by weight of a polyester elastomer “c” as another auxiliary material;

(4) 0.1 to 2 parts by weight of a mixture f containing a compound “d” having two epoxy groups and a compound “e” having three or more epoxy groups in a weight ratio of (95 to 40)/(5 to 60) as a binder; and

(5) 0.05 to 1 part by weight of an organic acid metal salt “g” as a catalyst;

turning the mixture “A” into block copolymer pellets by subjecting it to a uniform reaction under deaeration and dehydration in vacuum;

molding a composition containing 100 to 10 parts by weight of the obtained pellets and 0 to 90 parts by weight of PET “B” having an intrinsic viscosity of 0.60 to 0.80 dL/g into an unoriented film through a casting method; and

extending the unoriented film into an oriented film through a biaxial orientation method.

Second, there is provided a method of producing a weld-cut sealing/heat-shrinkable packaging film formed of a PET-based block copolymer polyester, characterized by:

melting at a temperature at or above its melting point a mixture “A” comprising:

(1) 100 parts by weight of a PET-based polyester “a” having an MFR (JIS method: 280° C., load of 2.16 Kg) of 45 to 130 g/10 minutes as a main raw material;

(2) 0 to 100 parts by weight of an ethylene glycol/cyclohexane dimethanol/phthalic acid copolyester “b” as an auxiliary material;

(3) 0 to 20 parts by weight of a polyester elastomer “c” as another auxiliary material;

(4) 0.1 to 2 parts by weight of a mixture “f” containing a compound “d” having two epoxy groups and a compound “e” having three or more epoxy groups in a weight ratio of (95 to 40)/(5 to 60) as a binder; and

(5) 0.05 to 1 part by weight of an organic acid metal salt “g” as a catalyst;

turning the mixture “A” into block copolymer by subjecting it to a uniform reaction under deaeration and dehydration in vacuum;

molding the obtained block copolymer into an unoriented film through a casting method; and

extending the unoriented film into an oriented film through a biaxial orientation method.

Third, there is provided a method of producing a weld-cut sealing/heat-shrinkable packaging film formed of a PET-based block copolymer polyester, characterized by:

melting a mixture “A” at a temperature of a melting point or higher which is composed of:

(1) 100 parts by weight of a PET-based polyester “a” having an MFR (JIS method: 280° C., load of 2.16 Kg) of 45 to 130 g/10 minutes as a main raw material;

(2) 0 to 100 parts by weight of an ethylene glycol/cyclohexane dimethanol/phthalic acid copolyester “b” as an auxiliary material;

(3) 0 to 20 parts by weight of a polyester elastomer “c” as another auxiliary material;

(4) 0.1 to 2 parts by weight of a mixture “f” containing a compound “d” having two epoxy groups and a compound “e” having three or more epoxy groups in a weight ratio of (95 to 40)/(5 to 60) as a binder; and

(5) 0.05 to 1 part by weight of an organic acid metal salt “g” as a catalyst;

turning the mixture “A” into block copolymer by subjecting it to a uniform reaction under deaeration and dehydration in vacuum;

molding the obtained block copolymer into an unoriented film through a casting method; and

extending the unoriented film into an oriented film through a biaxial orientation method.

Fourth, there is provided a method of producing a weld-cut sealing/heat-shrinkable packaging film formed of a PET-based block copolymer polyester, further characterized in that a temperature for molding the film into the oriented film through a biaxial orientation method is 80 to 100° C. in any one of the above-described first to third methods.

Fifth, there is provided a method of producing a weld-cut sealing/heat-shrinkable packaging film formed of a PET-based block copolymer polyester, characterized in that the weld-cut sealing/heat-shrinkable packaging film formed of a PET-based block copolymer polyester to be produced through any one of the above-described methods has a degree of heat-shrinkage of 30% or more at 130° C.

Sixth, there is provided a method of producing a weld-cut sealing/heat-shrinkable packaging film formed of a PET-based block copolymer polyester, characterized in that the weld-cut sealing/heat-shrinkable packaging film formed of a PET-based block copolymer polyester to be produced through any one of the above-described methods has a weld-cut sealing strength of 500 g/15 mm width or more.

Seventh, there is provided a method of producing a weld-cut sealing/heat-shrinkable packaging film formed of a PET-based block copolymer polyester, characterized in that the PET-based polyester “a” contains at least one selected from the group consisting of PET having an intrinsic viscosity of 0.60 to 0.80 dl/g, and a recycled product of a PET-based aromatic polyester molded product.

Eighth, there is provided a method of producing a weld-cut sealing/heat-shrinkable packaging film formed of a PET-based block copolymer polyester, characterized in that the compound “d” having two epoxy groups as a binder contains at least one selected from the group consisting of: aliphatic ethylene glycol diglycidyl ether, polyethylene glycol diglycidyl ether, and hexamethylene diglycidyl ether; alicyclic hydrogenated bisphenol A diglycidyl ether; and aromatic bisphenol A diglycidyl ether.

Ninth, there is provided a method of producing a weld-cut sealing/heat-shrinkable packaging film formed of a PET-based block copolymer polyester, characterized in that the compound “e” having three or more epoxy groups as a binder contains at least one selected from the group consisting of: aliphatic trimethylolpropane triglycidyl ether, glycerin triglycidyl ether, epoxidized soybean oil, and epoxidized linseed oil; heterocyclic triglycidyl isocyanurate; and aromatic phenol novolac epoxy resin and cresol novolac epoxy resin.

Tenth, there is provided a method of producing a weld-cut sealing/heat-shrinkable packaging film formed of a PET-based block copolymer polyester, characterized in that the coupling reaction catalyst “g” is a composite containing at least two kinds of salts selected from lithium salt, sodium salt, potassium salt, magnesium salt, calcium salt, zinc salt, and manganese salt of one of stearic acid and acetic acid.

Eleventh, there is provided a method of producing a weld-cut sealing/heat-shrinkable packaging film formed of a PET-based block copolymer polyester by means of a masterbatch according to any one of claims 1 to 10, characterized by involving:

melting at a temperature at or above its melting point a mixture A′ comprising:

(1) 100 parts by weight of a PET-based polyester “a” having an MFR (JIS method: 280° C., load of 2.16 Kg) of 45 to 130 g/10 minutes as a main raw material;

(2) 0 to 100 parts by weight of an ethylene glycol/cyclohexane dimethanol/phthalic acid copolyester “b” as an auxiliary material;

(3) 0 to 20 parts by weight of a polyester elastomer “c” as another auxiliary material;

(4) 1 to 15 parts by weight of a binder masterbatch “i” composed of 100 to 50 parts by weight of a mixture “f” containing a compound “d” having two epoxy groups and a compound “e” having three or more epoxy groups in a weight ratio of (95 to 40)/(5 to 60), and 100 parts by weight of a base substance “h” as a binder; and

(5) 0.5 to 5 parts by weight of a catalyst masterbatch “k” containing 5 to 15 parts by weight of an organic acid metal salt “g” and 100 parts by weight of a base substance “j” as a catalyst;

turning the mixture A′ into a block copolymer by subjecting it to a uniform reaction under deaeration and dehydration in vacuum; and

molding the obtained block copolymer into an oriented film through a biaxial orientation method or a tubular method.

### EFFECT OF THE INVENTION

A PET-based polyester packaging film capable of weld-cut sealing and heat-shrinkage according to the present invention has eliminated the most serious weak point in physical properties of conventional PET films. Thus, this film is useful for packaging of books, bottle sets, food containers, etc., for general packaging, packaging of industrial materials, and the like, and is further useful in the field of packing and packaging of daily commodities, civil engineering and construction members, electric and electronic members, and automobile vehicle members, etc. Moreover, this film can be produced through effective use of huge amount of recycled PET bottles as a prepolymer, and thus is also highly beneficial socially. Still further, even if incinerated after use, this film produces a combustion heat value lower than that of polyethylene or polypropylene. Thus, this film barely damages incinerators or the like, and emits no toxic gases.

### BEST MODE FOR CARRYING OUT THE INVENTION

In the present invention, examples of a PET-based polyester “a” as a main raw material for a mixture “A” include: PET which is massively produced worldwide as a PET-based aromatic polyester; and its copolymers. PET is particularly preferred. PET having an intrinsic viscosity (IV value) of 0.50 dl/g or more (corresponding to a melt flow rate (MFR) of about 210 g/10 minutes or less at a temperature of 280° C. and a load of 2.16 kgf through a JIS method) may be used, but PET having an intrinsic viscosity of 0.60 dl/g or more (MFR of about 130 g/10 minutes or less) is preferred. PET having an intrinsic viscosity of less than 0.50 dl/g may provide difficulties in molecular weight increase and melt viscosity increase, or may prevent a PET/polyester block copolymer from providing excellent molding workability and physical properties. The upper limit for the intrinsic viscosity is not particularly limited, but is generally 0.90 dl/g or less (MFR of about 25 g/10 minutes or more), and preferably 0.80 dl/g or less (MFR of about 45 g/10 minutes or more).

Under the present circumstances, PET bottle flakes or pellets formed of a PET-based polyester which is collected and recovered in large amounts are often used as a prepolymer. Normal PET bottles have a relatively high intrinsic viscosity, and thus a general recovered product PET bottles also have a high intrinsic viscosity of generally 0.60 to 0.80 dl/g (MFR of 130 to 45 g/minutes), and particularly 0.65 to 0.75 dl/g (MFR of 100 to 55 g/10 minutes). In general, the recovered PET bottle flakes are supplied as a 20 kg paper bag product and a 600 kg flexible container product, but usually contain a water content of about 3,000 to 6,000 ppm (0.3 to 0.6 wt %). Skeleton flakes of an A-PET sheet recovered in large amounts from a vacuum pressure molding factory are also suitable for the PET-based polyester “a” as a main raw material of the present invention.

For food packaging material, a PET resin for fiber and its fluff obtained through a polycondensation method can be used as a PET-based polyester “a”. The PET resin and its fluff generally has an intrinsic viscosity of 0.55 to 0.65 dl/g (MFR of 200 to 130 g/10 minutes), and preferably 0.60 to 0.65 dl/g (MFR of 130 to 100 g/10 minutes).

An ethylene glycol/cyclohexane dimethanol/phthalic acid copolyester may be used as an auxiliary material “b” of the present invention. A preferred example thereof is a transparent amorphous polymer Eastar PETG series, in particular, 6763 (intrinsic viscosity of 0.73, number average molecular weight (Mn) of 26,000, specific gravity of 1.27, glass transition temperature (Tg) of 81° C.) available from Eastman Chemical Company. Further, Skygreen series available from SK Chemicals may be used.

The ratio of the main raw material “a” to the auxiliary material “b” is 100/0 to 100/100. Of those, the ratio is preferably 100/10 to 100/90, and more preferably 100/40 to 100/70. A ratio of the main raw material “a” to the auxiliary material “b” of 100/10 or less provides a little effect in improving low temperature orientation molding property and heat-shrinkage properties. A ratio of the main raw material “a” to the auxiliary material “b” of 10/70 or more degrades orientation molding property and heat resistance and increases raw material costs.

A polyester elastomer may be used as auxiliary material “c” of the present invention. A thermoplastic polyester elastomer is generally a block copolymer of: an aromatic polyester such as polybutylene terephthalate (PBT) as a hard segment; and analiphatic polyether such as polytetramethylene glycol, or aliphatic polyester such as polycaprolactone as a soft segment. Examples thereof that can be used include: Hytrel series available from Toray Industries, Inc.; Pelprene P type and S type available from Toyobo Ltd.; and Nouvelan series 4000 (polyether type), 4100 (polyester type), and 4400 (new polyester type) available from Teijin Ltd. In particular, Nouvelan 4400 is preferred because it is effective for forming a transparent and flexible film and is inexpensive.

The ratio of the main raw material “a”/the auxiliary material “c” is 100/0 to 100/20. Of those, the ratio is preferably 100/2 to 100/10, and more preferably 100/5 to 100/7.5. A ratio of the main raw material “a”/the auxiliary material “c” of 100/2 or less provides a small effect of improving low temperature orientation molding property, softening property, and heat sealing property. A ratio of the main raw material “a”/the auxiliary material “c” of 100/20 or more causes yellowing of the film, degrades heat resistance, and increases raw material cost.

A commercially available PET resin having an intrinsic viscosity (IV) of 0.60 to 0.80 may be used as composition “B” of the present invention.

A commercially available PET resin having an IV of 0.60 or less has degraded film molding properties. A commercially available PET IV of 0.80 or more is expensive and has degraded film forming properties. The ratio of A /B is 100/0 to 10/90, preferably 80/20 to 20/80, and more preferably 70/30 to 30/70.

The coupling agent as a chain extender of the present invention is a compound having two epoxy groups or three or more epoxy groups in a molecule thereof (compound “d” and compound “e”, respectively).

Examples of the compound d having two epoxy groups can include: an aliphatic compound such as polyethylene glycol diglycidyl ether, polypropylene glycol diglycidyl ether, tetramethylene glycol diglycidyl ether, 1,6-hexamethylene glycol diglycidyl ether, neopentyl glycol diglycidyl ether, or glycerin diglycidyl ether; an alicyclic compound such as hydrogenated bisphenol A diglycidyl ether, hydrogenated diglycidyl isophthalate, 3,4-epoxycyclohexylmethyl-3,4-epoxycyclohexane carboxylate, or bis(3,4-epoxycyclohexyl)adipate; a heterocyclic compound such as diglycidyl hydantoin or diglycidyl oxyalkyl hydantoin; and an aromatic compound such as bisphenol A diglycidyl ether, an initial condensate of bisphenol A diglycidyl ether, diphenylmethane diglycidyl ether, diglycidyl terephthalate, diglycidyl isophthalate, or diglycidyl aniline.

Examples of the compound “e” having three or more epoxy groups can include: an aliphatic compound such as trimethylolpropane triglycidyl ether or glycerin triglycidyl ether; a heterocyclic compound such as triglycidyl isocyanurate, triglycidyl cyanurate, or triglycidyl hydantoin; and an aromatic compound such as triglycidyl para- or meta-aminophenol.

In addition, a compound having an intermediate number of epoxy groups such as a compound having an average of 2.1 or more to several epoxy groups can include a phenol/novolac/epoxy resin, a cresol/novolac/epoxy resin, or a biphenyldimethylene-based epoxy resin (for example, heat resistant epoxy resin NC-3000 series available from Nippon Kayaku Co. Ltd.). Other examples that can be used include compounds each having an average of 2.2, 3.6, 3.8, or 5.5 epoxy groups per molecule, which are commercially available from The Dow Chemical Company.

One characteristic of the present invention is selection of those binders. A “long chain branched structure” is introduced into PET by using compound “d” having two epoxy groups and compound “e” having three or more epoxy groups, and an e/d ratio is increased to increase the crystallization rate. It is assumed that compound “e” having three or more epoxy groups acts as a “crystallization nucleator at a molecular size level”. The “long chain branched structure” of the present invention may have a melt viscosity increased about 10 to 100 times that of a conventional “linear structure” by an “entanglement effect” of the molecular chains. Thus, film molding through a tubular method becomes possible. Further, introduction of the epoxy groups accelerates a polycrystalline effect and improves weld-cut sealing properties.

Binder mixture “f” of the present invention is a mixture containing: 100 to 0 wt % of compound “d” having two epoxy groups; and 0 to 100 wt % of the compound “e” having three or more epoxy groups. Increase in the amount of the latter compound “e” rapidly increases the swelling and melt viscosity of the resin. The weight ratio of the latter compound/the former compound (e/d) is generally 5/95 to 70/30, preferably 10/90 to 60/40, and more preferably 12.5/87.5 to 50/50. Increase in the e/d ratio increases the crystallization rate and allows reduction in draw down even of a raw fabric film. An e/d ratio of 5/95 or less provides such effects to a small extent. An e/d ratio of 60/40 or more causes difficulties in production itself of the PET-based polyester resin, and if a film can be made gel/fish eyes formed therein make the film unmarketable.

Another characteristic of the present invention is use of a binder masterbatch “i” with a base substance “h” as a diluent for preventing a localized reaction of the mixture “f” which may cause formation of gel/fish eye as a by-product in production of a film or sheet.

The binder masterbatch “i” contains 10 to 50 parts by weight of the mixture “f”, and 100 parts by weight of the base substance “h”. In this case, the binder masterbatch “i” preferably contains 15 to 25 parts by weight of the mixture “f”. having 10 parts by weight or less of the mixture “f” lessens the effect of the binder masterbatch “i” and requires relatively high cost. Having 50 parts by weight or more of the binder mixture “f” causes difficulties in production and drying of the binder masterbatch “i” and is liable to cause formation of a gel as a by-product through an excessive coupling reaction.

As the base substance “h”, a PET-based polyester having an intrinsic viscosity of 0.60 to 0.80 dl/g, recovered recycled product of a PET-based polyester molded product, a condensate of ethylene glycol/cyclohexane dimethanol/terephthalic acid/etc. (PETG available from Eastman Chemical Company, etc.), toluene, benzene, xylene, or the like may be used. In the case where the target molded product requires transparency, a PET-based polyester, toluene, benzene, xylene, or the like may be used. In the case where the target molded product requires no transparency, a polyethylene acrylate-based resin (available from Japan Polyethylene Corporation, etc.) or the like may also be used.

The mixing ratio of the binder masterbatch “i” is generally 1 to 10 parts by weight, and preferably about 2 to 5 parts by weight for favorable dispersion and mixing properties with respect to 100 parts by weight of the PET-based polyester “a” as a main raw material. Increase in the ratio of the binder masterbatch “i” reduces the MFR of the mixture “A” and the polyester block copolymer and increases melt viscosity.

The organic acid metal salt “g” as a catalyst in the present invention is a composite of several kinds of carboxylic acid metal salts. More preferably, the organic acid metal salt “g” is used as a masterbatch “k” in the present invention.

Use of one kind of carboxylic acid metal salt is not necessarily appropriate for the object of the present invention. Thus, the organic acid metal salt “g” is preferably a composite of several kinds of carboxylic acid metal salts.

A preferable example thereof includes a binary catalyst such as: lithium stearate/calcium stearate=20/80 to 50/100; sodium stearate/calcium stearate=20/80 to 50/100; potassium stearate/calcium stearate=20/80 to 50/100; manganese acetate/lithium stearate=20 to 50/100; or manganese acetate/calcium stearate=20 to 50/100.

A preferable example thereof further includes a ternary catalyst such as: lithium stearate/sodium stearate/calcium stearate=50/50/100; potassium stearate/sodium stearate/calcium stearate=50/50/100; lithium stearate/sodium acetate/ calcium stearate=50/50/100; or lithium stearate/manganese acetate/calcium stearate=50/50/100.

Still another characteristic of the present invention is use of the catalyst masterbatch “k” with a base substance “j” as a diluent for preventing a localized reaction in a vicinity of the organic acid metal salt “g” which may cause formation of gel/fish eye as a by-product in production of a film or sheet.

As the base substance “j”, a PET-based aromatic polyester having an IV of 0.50 to 0.90 dl/g, recovered recycled product of a PET-based aromatic polyester molded product, a condensate of ethylene glycol/cyclohexane dimethanol/terephthalic acid/etc. (PETG available from Eastman Chemical Company, etc.), a polyethylene acrylate-based resin (available from Japan Polyethylene Corporation, etc.), a polyacrylate-based resin (including a copolymer), or the like may be used similar to the base substance “h”. In the case where the target molded product requires transparency, a PET-based polyester, a polyacrylate-based resin (including a copolymer), or the like may be used. In the case where the target molded product requires no transparency, a polyethylene acrylate-based resin (available from Japan Polyethylene Corporation, etc.) or the like may also be used.

In the case where the above-mentioned resin is not used as the base substance “j”, calcium stearate having moderate catalytic activity and having a lubricating effect may be used as one kind of organic acid metal salt “g”. The organic acid metal salt g preferably contains calcium stearate in a ratio of 50 parts by weight or more. In this case, the organic acid metal salt g is in the form of powder and has a problem in workability regarding powder scattering. However, this organic acid metal salt “g” is inexpensive and is advantageously appropriate for small scale production.

The catalyst masterbatch k generally contains 5 to 15 parts by weight of the catalyst “g”, and 100 parts by weight of the base substance “j”. The catalyst masterbatch k more preferably contains 7.5 to 12.5 parts by weight of the catalyst “g” and 100 parts by weight of the base substance “j”, and most preferably 10 parts by weight of the catalyst “g” and 100 parts by weight of the base substance “j”. Having 5 parts by weight or less of the catalyst g provides a small effect of the catalyst masterbatch “k” and requires a relatively high cost. Having 15 parts by weight or more of the catalyst “g” undesirably causes difficulties in production itself of the catalyst masterbatch “k”, is liable to cause formation of a gel as a by-product during a coupling reaction, and causes hydrolysis of a resin obtained during molding.

The use amount of the catalyst masterbatch “k” is generally 0.25 to 10 parts by weight, and preferably about 0.5 to 5 parts by weight for favorable dispersion and mixing properties with respect to 100 parts by weight of the PET-based polyester “a” as a main raw material.

Examples of a reaction apparatus to be used for heat melting in the present invention include a single-screw extruder, a twin-screw extruder, a two-stage extruder which is a combination thereof, an extruder with kneader, a self-cleaning biaxial reaction apparatus generally used for production of a polycondensate of a PET-based polyester resin, and a batch type reaction chamber.

A high temperature reaction method to be employed in production of a polyester resin in the present invention is performed in a short period of time of about 2 to 10 minutes particularly in an extruder. Thus, L/D of a twin-screw extruder or single-screw extruder is preferably about 30 to 50, and particularly preferably about 36 to 45. According to the present invention, the main raw material and auxiliary materials “a”, “b”, and “c” react with one another rapidly within a generally short period of time, that is, a residence time of 30 seconds to 20 minutes, preferably 1 minute to 10 minutes, and particularly preferably 1.5 minutes to 5 minutes to produce the desired PET-based block copolymer polyester having increased molecular weight although depending on performance of the extruder.

In general, the reactive extrusion method involves a high speed reaction within a short period of time of several minutes, and thus gel/fish eye is liable to be formed as a by-product. In order to prevent the formation, the main raw material, auxiliary materials and binders are generally melt-kneaded in advance, and then the catalyst is fed from the side.

In the case where the reaction may take 30 minutes to 1 hour, a batch type reaction chamber is used, and this coupling reaction may be performed by adding the raw materials and the like in the above-mentioned order in the presence of a stabilizer.

In the case where a self-cleaning twin-screw reaction apparatus is used, this coupling reaction may be performed continuously by adding the raw materials and the like in a similar order in the presence of a stabilizer.

The reaction time for each of those cases is significantly shorter than a reaction time required for polycondensation or solid phase polymerization of 10 to 30 hours.

The above-mentioned reactive extrusion method preferably employs recovered PET bottle flakes or a fresh polyester resin as a main raw material dried with hot air at 110 to 140° C. in advance to reduce water content to 100 to 200 ppm, or recovered PET bottle flakes or a fresh polyester resin as a main raw material dried in dehumidified air to reduce water content to 50 ppm or less. The polyester resin generally adsorbs moisture in air and has a water content of 3,500 to 6,000 ppm (0.35 to 0.60 wt%) in accordance with a humid environment, and the object of the present invention can be attained stably through the above-mentioned drying treatment. The auxiliary materials are dried under respective drying conditions.

Meanwhile, in the case where the recovered PET bottle flakes or a fresh polyester resin which is undried is used with the auxiliary materials, the object of the present invention can be attained by: using an oil-sealed or dry and not water-sealed vacuum line for a twin-screw extruder; reducing the degree of vacuum of the first to third vents to 13.3×10³ Pa (100 mmHg) or less, preferably 2.6×10³ Pa (20 mmHg) or less, more preferably 0.66×10³ Pa (5 mmHg) or less, and further more preferably 0.26×10³ Pa (2 mmHg); and removing the water content through vacuum deaeration just after melting of the raw materials such as a polyester or during the melting and mixing thereof.

The most significant characteristic of the present invention is realization of significant improvement in workability in molding of an oriented film, weld-cut sealing strength, and heat-shrinkage ratio by: converting a PET-based polyester into a heat resistant weak weld-cut sealing film material having increased molecular weight and increased melt strength by a reaction with an epoxy-based binder and an alkali metal/alkali earth metal; and subjecting the resultant to block copolymerization with PETG and a polyester elastomer as auxiliary materials. Another most significant characteristic of the present invention is realization of a weld-cut sealing/heat-shrinkable packaging film formed of a PET-based block copolymer polyester through a biaxial orientation method, that is, molding working through a tubular method (double or triple bubble method), which was not possible with the conventional PET because of low melt strength.

The term “weld-cut sealing (Yohdan Seal: in Japanese)” as used herein refers to sealing providing an infinitely small sealing width formed in heat sealing, and cannot be attained by using a conventional heat sealing film. The conventional heat sealing film always requires a sealing part of 1 to 2 mm in width. Use of the weld-cut sealing/heat-shrinkable packaging film formed of a PET-based block copolymer polyester allows an infinitely small sealing width because of its excellent properties, to thereby realize this weld-cut sealing.

As described above, the weld-cut sealing requiring no sealing width involves linear bonding and not a real bonding, and has technical difficulties which cannot be attained with a conventional packaging film. The weld-cut sealing/heat-shrinkable packaging film formed of a PET-based block copolymer polyester of the present invention has physical properties required for such weld-cut sealing, that is, excellent weld-cut sealing properties.

The conventional heat sealing film does not have excellent heat-shrinkage properties, and cannot realize three-dimensional packaging of heavy-gauge boxes, heavy-gauge containers, bottles, and the like. The conventional heat sealing film was limited to applications requiring unoriented flat film such as waste bags. The weld-cut sealing/heat-shrinkable packaging film formed of a PET-based block copolymer polyester of the present invention has physical properties required for such three-dimensional packaging, that is, excellent heat-shrinkage properties.

As described above, the present invention allows production of the weld-cut sealing/heat-shrinkable packaging film formed of a PET-based block copolymer polyester realizing weld-cut sealing and heat-shrinkage.

### EXAMPLES

Next, the present invention will be described in more detail based on examples. Methods of evaluation in the examples are as described below.

(1) Intrinsic viscosity: The intrinsic viscosity was measured at 25° C. with a Cannon-Fenske viscometer by using a mixed solvent of 1,1,2,2-tetrachloroethane and phenol in equal weights for an aromatic saturated polyester.

(2) MFR: The MFR was measured in accordance with condition 20 of JIS K7210 and at a temperature of 280° C. and a load of 2.16 kg for a PET-based polyester and a PET-based polyester/aromatic saturated polyester block copolymer.

(3) Swell: A melt indexer for MFR was used, and a sample was allowed to run under the conditions of a temperature of 280° C. and a load of 2.16 kg. The sample was cut after it had run for 2.0 cm, and its diameter at 5.0 mm from a lower end was measured. The swell was measured by using the following calculation formula.
Swell (%)=[(Average of diameters−2.095)/2.095]×100

(4) Molecular weight: The molecular weight of a PET-based polyester was measured under the following conditions through a GPC method.

(Main body) SYSTEM-21 manufactured by Showa Denko K. K.

(Column) Shodex KF-606M (two columns) for sample and reference

(Solvent) Hexafluoroisopropyl alcohol

(Column temperature) 40° C.

(Injection amount) 20 μl

(Flow rate) 0.6 ml/minute

(Polymer concentration) 0.15 wt %

(Detector) Shodex RI-74

(Molecular weight conversion standard) PMMA: Shodex M-75

(5) DSC measurement: DSC was measured by using DSC220 manufactured by Seiko Instruments Inc. with a sample of 5 to 15 mg, a nitrogen flow rate of 50 mL/minute, and a temperature increase rate of 10° C./minute at 20 to 300° C.

(6) Weld-cut sealing (Yohdan Seal) strength: The weld-cut sealing strength was measured by using an L-type sealing machine VT450 manufactured by Kyowa Denki Co., Ltd. Two films of the present invention were attached together as they are, and were pressed together with electromagnets, to thereby automatically weld-cut seal the films in 2 seconds. The film having a weld-cut part was cut into a sample of 15 mm in width, and the weld-cut sealing strength of the sample was measured at a tension speed of 100 mm/minute by using Tensilon STA-1150 manufactured by Orientec Co., Ltd.

(7) Measurement of degree of film heat-shrinkage: The film was cut into a sample of 15 mm in width×15 cm in length, and two lines were drawn 10 cm apart in a center part of the film. The film was hung in an electric furnace at a predetermined temperature of 60 to 180° C. (usually 90 to 130° C.) for 2 minutes, to thereby measure a distance of heat-shrinked two lines in the center part of the film.

(8) Shrink packaging test and weld-cut sealing strength: Shrink Tunnel VS500 manufactured by Kyowa Denki Co., Ltd. was used. A food tray or a food box was held between two films of the present invention, and the whole was weld-cut sealed. A shrink test was performed at a temperature of 140° C. while the weld-cut sealed product was allowed to pass a conveyer length of about 1 m in 2 to 3 seconds. The film having a weld-cut part was cut into a sample of 15 mm in width, and the weld-cut sealing strength of the sample was measured at a tension speed of 100 mm/minute by using Tensilon STA-1150 manufactured by Orientec Co., Ltd.

(9) Measurement of mechanical properties: The tensile test of the film of the present invention was performed at a tensile speed of 50 to 500 mm/minute by using Tensilon in accordance with JIS K7113.

(10) Melt viscosity: The melt viscosity was measured by using Dyn Alyser DAR-100 manufactured by REOLOGICA Instruments AB (Sweden) and by applying torsional vibration to a sample piece of 2 cm square×2 mm in thickness held between hot plates at 280° C. in a nitrogen atmosphere.

### Production Examples 1 to 5

### Binder Master batches “i1” to “i5”

### Production Example 1

A mixture of 70 parts by weight of Clear flakes (recovered product of PET bottle, intrinsic viscosity of 0.73 dl/g, MFR of 40.4 g/10 minutes, PET content of 99.9%) available from Yono PET Bottle Recycle dried with hot air at 120° C. for about 12 hours, and 30 parts by weight of a dried bag product of PET NEH-2050 (IV of 0.80, specific gravity of 1.35) available from Unitika Ltd. was extruded by using a twin-screw extruder ZA40A-40D manufactured by Berstorff GmbH (diameter of 43 mm, L/D=37, and three-stage water-sealed vacuuming) at a set temperature of 260 to 270° C., a screw speed of 150 rpm, a first vent of about −600 mmHg, a third vent of about −670 mmHg, and at an automatic resin supply speed of 35 Kg/h. To this 15 parts by weight of ethylene glycol diglycidyl ether (Epolite 40E, epoxy equivalent of 135 g/eq, pale yellow liquid, available from Kyoei Kagaku Kogyo) as a binder “d” (bifunctional epoxy compound) was injected and mixed there into from a second vent port by using a metering pump. Five strands flowing out of a die of 3.5 mm in diameter were cooled with water, and were formed into mini pellets by cutting the strands with a rotational cutter. Batches of 100 Kg of the obtained mini pellets were each dried with hot air at 130° C. for about 0.5 hour and then at 80° C. for about 12 hours, and the resultant was stored in moisture-proof bags (three layer of paper/aluminum/polyethylene) (binder masterbatch “i1”: e/d=0/100).

### Production Example 2

Similarly, 15 parts by weight of a mixture containing 75 parts by weight of ethylene glycol diglycidyl ether, and 25 parts by weight of trimethylolpropane triglycidyl ether (Epolite 100MF, epoxy equivalent of 150 g/eq, pale yellow liquid, available from Kyoei Kagaku Kogyo) as a binder “e” (trifunctional epoxy compound) was injected by using a metering pump. Five strands flowing out of a die of 3.5 mm in diameter were cooled with water, and were formed into mini pellets by cutting the strands with a rotational cutter. Batches of 100 Kg of the obtained mini pellets were each dried with hot air at 130° C. for about 0.5 hour and then at 80° C. for about 12 hours, and the resultant was stored in moisture-proof bags (three layer of paper/aluminum/polyethylene) (binder masterbatch “i2”: e/d=25/75).

### Production Example 3

Similarly, 15 parts by weight of a mixture containing 50 parts by weight of ethylene glycol diglycidyl ether, and 50 parts by weight of trimethylolpropane triglycidyl ether were injected by using a metering pump. Five strands flowing out of a die of 3.5 mm in diameter were cooled with water, and were formed into mini pellets by cutting the strands with a rotational cutter.

Batches of 100 Kg of the obtained mini pellets were each dried with hot air at 130° C. for about 0.5 hour and then at 80° C. for about 12 hours, and the resultant was stored in moisture-proof bags (three layer of paper/aluminum/polyethylene) (binder masterbatch “i3”: e/d=50/50).

### Production Example 4

Similarly, 80 parts by weight of clear flakes available from Yono PET Bottle Recycle dried with hot air, and 20 parts by weight of PET G Skygreen S2008 available from SK Chemicals (Korea) dried at 70° C. were extruded by using a twin-screw extruder manufactured by Berstorff GmbH at a set temperature of 260 to 270° C., a screw speed of 150 rpm, a first vent of about −600 mmHg, a third vent of about −670 mmHg, and at an automatic resin supply speed of 35 Kg/h. To this 15 parts by weight of a mixture containing 87.5 parts by weight of 1,6-hexanediol diglycidyl ether (Adeka Glycirol ED-503, epoxy equivalent of 165 g/eq, colorless liquid, available from Asahi Denka Co., Ltd.) as a binder “d”, and 12.5 parts by weight of glycerin triglycidyl ether (Adeka Glycirol ED-507, epoxy equivalent of 145 g/eq, colorless liquid, available from Asahi Denka Co., Ltd.) as a binder “e” was injected there into by using a metering pump. Five strands flowing out of a die of 3.5 mm in diameter were cooled with water, and were formed into mini pellets by cutting the strands with a rotational cutter.

Batches of 100 Kg of the obtained mini pellets were each dried with hot air at 130° C. for about 0.5 hour and then at 80° C. for about 12 hours, and the resultant was stored in moisture-proof bags (three layer of paper/aluminum/polyethylene) (binder masterbatch “i4”: e/d=12.5/87.5).

### Production Example 5

Similar to Production Example 4, 7.5 parts by weight of tetra functional epoxidized soybean oil (Adeka Cizer O-130P, epoxy equivalent of 232 g/eq, yellow viscous liquid, available from Asahi Denka Co., Ltd.) as a binder “e” was injected by using a metering pump. Five strands flowing out of a die of 3.5 mm in diameter were cooled with water, and were formed into mini pellets by cutting the strands with a rotational cutter.

Batches of 100 Kg of the obtained mini pellets were each dried with hot air at 130° C. for about 0.5 hour and then at 80° C. for about 12 hours, and the resultant was stored in moisture-proof bags (three layer of paper/aluminum/polyethylene) (binder masterbatch “i5”: e/d=100/0).

### Production Examples 6 to 8

### Catalyst Master batches “k1” to “k3”

### Production Example 6

A lubricant and 50 parts by weight of calcium stearate as a base substance for a masterbatch were added to 25 parts by weight of lithium stearate and 25 parts by weight of sodium stearate. This mixture was mixed to be uniform by using a tumbler, to thereby obtain apowdered composite catalyst masterbatch “k1”: Li/Na/Ca=25/25/50.

### Production Example 7

A lubricant and 50 parts by weight of calcium stearate as a base substance for a masterbatch were added to 50 parts by weight of potassium stearate and 50 parts by weight of sodium stearate. This mixture was mixed to be uniform by using a tumbler, to thereby obtain a powdered composite catalyst masterbatch “k2”: K/Ca=50/50.

### Production Example 8

A mixture of 50 parts by weight of a dried product of Clear flakes (recovered product of PET bottle, intrinsic viscosity of 0.725 dl/g, MFR of 56 g/10 minutes, zero share melt viscosity of 690 Pa·s at 280° C.) available from Yono PET Bottle Recycle, 50 parts by weight of a dried product of PETG 6763 (IV of 0.73, density of 1.27) available from Eastman Chemical Company, and a powdered composite catalyst containing 2.5 parts by weight of lithium stearate, 2.5 parts by weight of sodium stearate, and 5.0 parts by weight of calcium stearate were melted and mixed with the powdered composite catalyst supplied from the side by using a twin-screw extruder manufactured by Berstorff GmbH (diameter of 43 mm, L/D=37, and three-stage water-sealed vacuuming). The mixture was extruded at a set temperature of 260° C., a screw speed of 150 rpm, a first vent of about −630 mmHg, a third vent of about −730 mmHg, and a tan automatic resin supply speed of 30 Kg/h. Five strands flowing out of a die of 3.0 mm in diameter were cooled with water, and were formed into pellets by cutting the strands with a rotational cutter. About 10 Kg of the obtained pellets were dried with hot air at 140° C. for about 1 hour and then at 120° C. for about 12 hours, and the resultant was stored in a similar moisture-proof bag (pelletized composite catalyst masterbatch “k3”: 10 parts by weight of catalyst (Li/Na/Ca=25/25/50)/100 parts by weight of base substance).

### Production Example 9

### Production of PET Resin Pellets “A1” having Increased Molecular Weight and Increased Melt Strength (e/d=12.5/87.5) by Using Twin-Screw Extruder

100 parts by weight of an undried product of Clear flakes (recovered product of PET bottle, PET content of 99.9%, intrinsic viscosity of 0.72 dl/g, MFR of 57 g/10 minutes, swell of 10%, molecular weights Mn of 11,500 and Mw of 27,800, and Mw/Mn=2.4) available from Yono PET Bottle Recycle, 4 parts by weight (effective amount of 0.52 part by weight) of the masterbatch “i1” containing ethylene glycol diglycidyl ether as the binder “d” (Production Example 1: e/d=0/100), 4 parts by weight (effective amount of 0.52 part by weight) of the masterbatch “i3” containing trimethylolpropane triglycidyl ether as the binder e (Production Example 3: e/d=50/50), and 0.15 part by weight of the powdered composite catalyst masterbatch “k1” (Production Example 6: Li/Na/Ca=25/25/50) were mixed for 5 minutes with a tumbler mixer. The mixture was extruded by using a twin-screw extruder PCM-70 manufactured by Ikegai, Ltd. with an oil-sealed vacuum line (diameter of 70 mm, L/D=37, and three vent method) at a set temperature of 280° C., a screw speed of 100 rpm, a first vent of about 0.096 MPa, second and third vents of about 0.098 MPa, and at an automatic supply speed of 50 Kg/h, dehydrated, deaerated, and mixed for a reaction. Ten strands were extruded into water, and were formed into pellets by cutting the strands with a rotational cutter. The obtained pellets were dried with hot air at 140° C. for about 3.5 hours, and the resultant was stored in a similar moisture-proof bag. PET pellets “A1” having increased molecular weight and increased melt strength and prepared from the recovered PET bottle as a raw material had an average MFR of 2.6 g/10 minutes (IV value of 0.99), and were obtained in an yield of about 300 Kg.

### Production Example 10

### Production of Resin Pellets “A2” Having Increased Molecular Weight and Increased Melt Strength (e/d=12.5/87.5) by Using Tandem-Type Extruder

A mixture of 100 parts by weight of an undried product of Clear flakes (recovered product of PET bottle, intrinsic viscosity of 0.74 dl/g, and MFR of 40 g/10 minutes available from Yono PET Bottle Recycle, 4.5 parts by weight (effective amount of 0.59 part by weight) of the masterbatch i2 containing ethylene glycol diglycidyl ether as the binder d and trimethylolpropane triglycidyl ether as the binder e (Production Example 2: e/d=25/75), and 0.20 part by weight of the powdered composite catalyst masterbatch “k1” (Production Example 6: Li/Na/Ca=25/25/50) were mixed for 2 minutes with a tumbler mixer. As a first stage of the tandem method, the mixture was extruded with a twin-screw extruder TEX-30 manufactured by Japan Steel Works, Ltd. with an oil-sealed vacuum line (diameter of 30 mm, L/D=32, and two vent method) at a set temperature of 270 to 280° C., a screw speed of 40 rpm, a first vent of about 0.096 MPa, a second vent of about 0.098 MPa, and at an automatic supply speed of 40 Kg/h, dehydrated, deaerated, and mixed for a reaction. As a second stage of the tandem method, the mixture was converted into a high polymer by using a single-screw extruder manufactured by Hitachi Zosen Corporation (diameter of 90 mm, screw speed of 40 rpm). A sheet from a T-die of 500 mm×1 mm in width was cooled with air, and was formed into angular pellets by cutting the sheet with a rotational cutter. The obtained pellets were dried with hot air at 140° C. for about 3.5 hours, and the resultant was stored in a similar moisture-proof bag. High polymer pellets A2 of the present invention prepared from the recovered PET bottles as a raw material had an average MFR of 5.4 g/10 minutes (IV value of 0.96), and were obtained with a yield of about 80 Kg.

### Production Example 11

### Production of PET Resin Pellets “A3” Having Increased Molecular Weight and Increased Melt Strength by Using Tandem-Type Extruder

Substantially similar to Production Example 10, 100 parts by weight of an undried product of Clear flakes available from Yono PET Bottle Recycle, 3.0 parts by weight (effective amount of 0.39 part by weight) of the masterbatch i4 containing 1,6-hexanediol diglycidyl ether as the binder “d” and glycerin triglycidyl ether as the binder “e” (Production Example 4: e/d=12.5/87.5), 4.3 parts by weight (effective amount of 0.30 part by weight) of the binder masterbatch i5 containing 7.5 parts by-weight of epoxided soybean oil (Production Example 5: e/d=100/0), and 0.20 part by weight of the powdered composite catalyst masterbatch “k1” (Production Example 6: Li/Na/Ca=25/25/50) were mixed for 2 minutes with a super mixer.

A coupling reaction was completed by using a similar tandem-type extruder. A sheet from a T-die of 500 mm×1 mm in width was cooled with air, and was formed into angular pellets by cutting the sheet with a rotational cutter. The obtained pellets were dried with hot air at 140° C. for about 3.5 hours, and the resultant was stored in a similar moisture-proof bag. High polymer pellets “A3” of the present invention prepared from recovered PET bottles as a raw material had an average MFR of 8.5 g/10 minutes (IV value of 0.88 and zero share melt viscosity of 3,800 Pa·s at 280° C.), and were obtained with a yield of about 80 Kg.

### Production Examples 12 and 13

### Production of PET/Polyester Elastomer Block Copolymer Resin Pellets B1 and B2 by Using Tandem-Type Extruder

### Production Example 12

A mixture of 100 parts by weight of a dried product of PET pellets prepared through a polycondensation method (fiber grade fresh product, intrinsic viscosity of 0.61 dl/g, MFR of 85 g/10 minutes) available from TUNTEX (Taiwan), 10 parts by weight of dried pellets of polyester elastomer Nouvelan 4000 (polyether type TRB-EL6, MFR of 30 g/10 minutes at 230° C., specific gravity of 1.23) available from Teijin Ltd., 3.5 parts by weight (effective amount of 0.46 part by weight) of the masterbatch i4 (Production Example 4: e/d=12.5/87.5) containing 1,6-hexanediol diglycidyl ether as the binder “d” and glycerin triglycidyl ether as the binder e, 4.3 parts by weight (effective amount of 0.30 part by weight) of the binder masterbatch i5 (Production Example5: e/d=100/0) containing 7.5 parts by weight of tetrafunctional epoxidized soybean oil as the binder “e”, and 0.20 part by weight of the low temperature active powdered composite catalyst masterbatch “k2” (Production Example 7: K/Ca=50/50) was mixed with a super mixer for 2 minutes.

Substantially similar to Production Example 11, a coupling reaction was completed at 260° C. by using a tandem-type extruder. A sheet from a T-die of 500 mm width×1 mm thick was cooled with air, and was formed into angular pellets by cutting the sheet longitudinally and transversely with a rotational cutter. The obtained pellets were dried with hot air at 130° C. for about 5 hours, and the resultant was stored in a similar moisture-proofbag. PET/PES rubber block copolymer pellets B1 of the present invention prepared from the recovered PET bottles as a raw material had an average MFR of 9.0 g/10 minutes, and were obtained in a yield of about 80 Kg. The DSC revealed that the PET/PES rubber block copolymer pellets “B1” had a glass transition temperature of 71.4° C., a crystallization temperature of 116° C., a heat of crystallization of −33.4 J/g, a melting point of 250° C., a heat of melting of 58.0 J/g, and a degree of crystallization of 17.6%.

### Production Example 13

PET/PES rubber block copolymer pellets “B2” were obtained in the same manner as in Production Example 12 except that a dried product of polyester elastomer Nouvelan 4400 (polyester type TRB-ELA, product under development) available from Teijin Ltd. was used. The PET/PES rubber block copolymer pellets “B2” had an average MFR of 8.5 g/10 minutes and were obtained in a dry yield of about 80 Kg.

### Production Example 14

### Production of PET/PETG/Polyester Elastomer Block Copolymer Pellets “C1” by Using Single-Screw Press Kneading Extruder

A mixture of 100 parts by weight of dried pale blue PET pellets prepared through a polycondensation method (main raw material a: fiber grade fresh product, intrinsic viscosity of 0.61 dl/g, MFR of 85 g/10 minutes at 280° C) available from TUNTEX (Taiwan), 30 parts by weight of dried transparent pellets PETG 6763 (auxiliary material “b”: fresh product, intrinsic viscosity of 0.73 dl/g, MFR of 120 g/10 minutes at 280° C., Mn of 26,000) available from Eastman Chemical Company, 5 parts by weight of dried brown pellets of a polyester elastomer Nouvelan 4400 series (auxiliary material c: novel polyester type TRB-ELA, MFR of about 40 g/10 minutes at 230° C.) available from Teijin Ltd., 9.5 parts by weight (effective amount of 1.23 parts by weight, e/d=25/75) of transparent mini pellets as the binder masterbatch “i2”, 0.30 part by weight of the powdered composite catalyst masterbatch “k1” (Production Example 6: Li/Na/Ca=25/25/50), 0.1 part by weight of IRGANOX B225 powder as an antioxidant/color protection agent, and 0.15 part by weight of liquid paraffin as a spreader for the powder were mixed with a super mixer for 2 minutes. The mixture was stored in a similar moisture-proof bag.

The flake mixture was extruded by using a single-screw press kneading extruder manufactured by Hoshi Plastics (screw diameter of 100 mmΦ, actual L/D=32, one vent-type, pitch between flights of substantially half, mixing screw-type) at a set cylinder temperature of 250 to 260° C., a set die temperature of 270° C., a degree of vacuum of a vent port of −0.1 MPa or less, a screw speed of 20 rpm, and at a flake mixture supply speed of 60 Kg/h. Nine obtained strands were cooled with water, and were formed into cylindrical pellets by cutting the strands with a rotational cutter. The obtained pellets were dried with hot air at 130° C. for about 3 hours, and the resultant was stored in a similar moisture-proof bag. The obtained PET/PETG/PES elastomer block copolymer pellets C1 (composition ratio: 100/30/5) of the present invention had an MFR of 6.4 g/10 minutes and a zero share melt viscosity of 7,900 Pa·s at 280° C., and were obtained in a yield of about 100 Kg.

### Examples 1 to 3

### Production of Weld-Cut Sealing/Heat-Shrinkable Packaging Films “F1” to “F3” Through Biaxial Orientation Method, and Evaluation of Physical Properties

Into 40, 20, 10, and 0 part by weight of the dried PET pellets “A1” having increased molecular weight and increased melt strength of the present invention (MFR of 2.6 g/10 minutes, IV value of 0.99, Production Example 9), 60, 80, 90, and 100 parts by weight of dried commercially available PET pellets (MFR of 120 g/10 minutes, IV value of 0.60) were mixed respectively for 1 minute by using a super mixer. Each of the mixtures was extruded at 270° C. from a T-die of 300 mm in width by using a single-screw extruder having a diameter of 40 mm, and was formed into an A-PET sheet having a thickness of about 300 μm by using cold stretch rolls. Then, the resultant was biaxially oriented longitudinally and transversely 3.5×3.5 times at 90° C., and was heat set at 90° C., to thereby produce biaxially oriented films having a thickness of 15 μm (respectively referred to as Examples F1, F2, and F3, and Comparative Example H1).

Table 1 shows the results of the weld-sealing strength test, impact strength test of a weld-cut sealed part, and thermal analysis through DSC. Those tests were performed at a temperature of 270° C., and the results represent an average value of 5 points. The films F1 to F3 of the present invention each had an improved weld-cut sealing strength compared with those of Comparative Examples H1 and H2 (commercially available biaxially oriented PET films) containing no PET resin “A1” of the present invention. The products of the present invention each had a higher impact strength of a weld-cut sealed part of 2.3 to 3.1 Kg·cm compared with that of a commercially available oriented propylene film (IOPP of about 1.5 Kg·cm). However, the products of the present invention each had half the weld-cut strength of IOPP of 1 Kg/15 mm or more.

DSC revealed that the films F1 to F3 of the present invention each had a melting point reduced by 3° C. and a degree of crystallization reduced by about 3% with respect to those of Comparative Example H1 containing no PET resin A1 of the present invention. The reduction presumably results from a “polycrystalline effect” and presumably causes improvement in weld-cut sealing strength and impact strength of a weld-cut sealed part. In a DSC chart, neither glass transition temperature (Tg) nor crystallization temperature (Tc) appeared for any of the films F1 to F3, indicating that the films F1 to F3 were each formed of a highly crystalline product.

TABLE 1
Table 1: Results of weld-cut sealing test and DSC measurement

| | | | | Impact | | | |
|---|---|---|---|---|---|---|---|
| | | | Weld-cut | strength of | | | |
| | Film [ratio of | | sealing | weld-cut | Melting | | Degree of |
| | mixing A1/PET | Thickness | strength | sealed part | Temperature | Heat | crystallization |
| Example | (IV 0.60) in wt %] | (μm) | (Kg/15 mm) | (Kg · cm) | (° C.) | (J/g) | (%) |
| 1 | F1[40/60] | 15 | 0.51 | 2.3 | 251 | 49.9 | 35.7 |
| 2 | F2[20/80] | 15 | 0.55 | 2.8 | 253 | 52.1 | 37.1 |
| 3 | F3[10/90] | 15 | 0.54 | 3.1 | 254 | 52.1 | 37.1 |
| * | H1[0/100] | 15 | 0.45 | 1.5 | 254 | 55.3 | 39.3 |
| # | H2 | 12 | 0.46 | 1.3 | 255 | 50.5 | 36.1 |

* Comparative Example
# Comparative Example 2: commercially available biaxial PET alone

### Examples 4 and 5

### Production of Weld-Cut Sealing/Heat-Shrinkable Packaging Films F4 and F5 Through Biaxial Orientation Method, and Evaluation of Shrinkable Packaging Properties

Into 50 and 10 parts by weight of the dried PET pellets “A2” having increased molecular weight and increased melt strength of the present invention (MFR of 5.4 g/10 minutes, IV value of 0.96, Production example 10), 50and 90 parts by weight of dried commercially available PET resins (MFR of 80 g/10 minutes, IV value of 0.72) were mixed respectively for 1 minute by using a super mixer. Each of the mixtures was extruded at 270° C. from an extruding die of 300 mm in width by using a single-screw extruder, and was formed into an A-PET sheet by using chilled rolls. Then, the resultant was biaxially oriented longitudinally and transversely 3.5×3.5 times at 85 to 90° C., and was not heat-set at it was, to thereby produce a biaxially oriented film having a thickness of 12 μm (respectively referred to as Examples F4 and F5).

As Comparative Example H3, a film was produced under the same conditions except that the film contained no PET resin “A2” of the present invention at all. Comparative Example H2 in Table 2 refers to a commercially available biaxially oriented film as described above. However, it is heat-set unlike Comparative Example H3 and thus is described as a reference example which is not subjected to heat shrinkage.

Shrink Tunnel VS500 manufactured by Kyowa Denki Co., Ltd. was used for a shrink test and weld-cut sealing strength measurement. A food box (14.5 cm length×8 cm width×3.3 cm height) or a round food cup (14.5 cm top×8 cm bottom×4 cm height) was held between two films of the present invention, and the whole was weld-cut sealed automatically by using a weld-cut sealing machine VT450manufactured by Kyowa Denki Co., Ltd. The weld-cut sealed product was subjected to heat shrinkage at a temperature of 130 to 140° C. while it was allowed to pass a conveyer length of about 1 m in 2 to 3 seconds. The obtained film having a weld-cut part was cut into a sample of 15 mm in width, and the weld-cut sealing strength of the sample was measured at a tension speed of 100 mm/minute by using Tensilon STA-1150 manufactured by Orientec Co., Ltd.

Table 2 shows the results of weld-cut sealing strength measurement. The weld-cut sealing was performed at a temperature of about 270° C., and an average weld-cut sealing value refers to an average of measured values at 5 points. The films “F4” and “F5” of the present invention each had a weld-cut sealing strength improved by 1.4 to 1.8 times with respect to those of Comparative Examples H2 and H3 containing no PET resin “A2” of the present invention.

The biaxially oriented film “F4” of the present invention had a heat-shrinkage ratio of 11% at 80° C. for 10 minutes, and 40% at 130° C. for 10 minutes in one direction. Meanwhile, the commercially available biaxially oriented PET film (Comparative Example H2) had no heat-shrinkage property.

DSC revealed that the film “F4” of the present invention had no glass transition temperature (Tg) although it was not heat-set, a crystallization temperature of 114° C., a heat of crystallization of −3.3 J/g, a melting point of 256° C., a heat of melting of 50 J/g, and a degree of crystallization of 33.4%. The films “F4” and “F5” of the present invention each contained the PET resin “A2” and had an improved weld-cut sealing strength compared with those of Comparative Examples H2 and H3owing to the “polycrystalline effect”.

TABLE 2
Table 2: Measurements of weld-cut sealing test

| | Film [ratio of | | Weld-cut sealing strength after | | | | | Average value |
|---|---|---|---|---|---|---|---|---|
| | mixing A2/PET | | heat-shrinkage measured at 5 | | | | | of 5 points |
| | (IV 0.72) in | Thickness | points | | | | | (Kg · 15 mm) |
| Example | wt %] | (μm) | (Kg/15 mm) | | | | | [ratio] |
| 4 | F4[50/50] | 12 | 1.23 | 1.04 | 1.02 | 0.45 | 0.46 | 0.840[1.8] |
| 5 | F5[10/90] | 12 | 0.75 | 0.47 | 0.74 | 0.46 | 0.65 | 0.614[1.4] |
| * | H3[0/100] | 12 | 0.51 | 0.56 | 0.23 | 0.21 | 0.71 | 0.444[1.0] |
| # | H2 | 12 | 0.54 | 0.64 | 0.28 | 0.50 | 0.34 | 0.460[1.0] |

* Comparative Example 3
# Comparative Example 2: commercially available biaxial PET alone

### Examples 6 to 8

### Production of Weld-Cut Sealing/Heat-Shrinkable Packaging Films “F6” to “F8” Through Biaxial Orientation Method, and Evaluation of Heat-Shrinkable Packaging

### Example 6

Into 90 parts by weight of the dried block copolymer PET pellets “B1” having increased molecular weight and increased melt strength of the present invention (MFR of 9.0 g/10 minutes, 10 parts by weight of polyether elastomer 6 was used, Production Example 12), 10 parts by weight of a dried commercially available PET resin (MFR of 80 g/10 minutes, IV value of 0.72) was mixed for 2 minutes by using a super mixer. This mixture was extruded at 270° C. from an extruding die 300 mm in width by using a single-screw extruder having a diameter of 40 mm, and was formed into an A-PET sheet by using chilled rolls. Then, the resultant was biaxially oriented longitudinally and transversely 3.5×3.5 times at 85 to 90° C., to thereby produce an oriented film (F6) having a thickness of 12 μm without heat-setting. A film produced to have a thickness of 9 μm tore easily.

### Examples 7 and 8

Into 90 parts by weight of the dried block copolymer PET pellets “B2” having increased molecular weight and increased melt strength of the present invention (MFR of 8.5 g/10 minutes, 10 parts by weight of novel polyester-type elastomer “A”, Production Example 13), 10 parts by weight of dried commercially available PET resins (MFR of 80 g/10 minutes, IV value of 0.72) were mixed for 2 minutes by using a super mixer. Each of the mixtures was extruded at 270° C. from an extruding die 300 mm in width by using a single-screw extruder having a diameter of 40 mm, and was formed into an A-PET sheet by using chilled rolls. Then, the resultant was biaxially oriented longitudinally and transversely 3.5×3.5 times at 85 to 90° C., to thereby produce oriented films each having a thickness of 12 μm and 9 μm (F7 and F8, respectively) without heat-setting.

Table 3 shows the results of weld-cut sealing strength measurement (after heat-shrinkable packaging) for the films “F7” and “F8”. The weld-cut sealing was performed at a temperature of about 270° C., and an average weld-cut sealing value refers to an average of measured values at 5 points. The weld-cut sealing strength was measured for two cases, that is, a case where a film was not subjected to heat-shrinkage and a case where a film was used for heat-shrinkable packaging of a cylindrical container. The film of the latter case had better weld-cut sealing strength by about 20%. The films “F7” and “F8” of the present invention each had a significantly improved weld-cut sealing strength of about 2 times that of the biaxially oriented PET film formed of a resin containing no polyester elastomer “A” of the present invention. The oriented film “F8” having a thickness of 9 μm was more flexible than the oriented film “F7” having a thickness of 12 μm and was an excellent packaging material.

TABLE 3
Table 3: Measurements of weld-cut sealing test after heat-shrinkable packaging

| | | | | | | | | | Average |
|---|---|---|---|---|---|---|---|---|---|
| | Type of | | | | | | | | value at 5 |
| | resin | | | | | | | | points |
| | B/PET* | | | Weld-cut sealing strength^{#} after | | | | | (Kg/15 mm) |
| | [ratio in | | Thickness | heat-shrinkable packaging | | | | | Ratio for |
| Example | wt %] | Film | (μm) | (Kg/15 mm) | | | | | 0.45^{$} |
| 6 | B1 | F6 | 12 | 1.86 | 0.84 | 0.61 | 1.52 | 0.66 | 0.83[1.8] |
| | [90/10] | | | | | | | | |
| 7 | B2 | F7 | 12 | 1.15 | 2.06 | 0.66 | 0.93 | 1.38 | 1.24[2.8] |
| | [90/10] | | | | | | | | |
| 8 | B2 | F8 | 9 | 0.48 | 0.45 | 0.66 | 1.38 | 1.12 | 0.818[1.8] |
| | [90/10] | | | | | | | | |

*PET had an IV value of 0.72
^{#}Measured at 5 points
^{$}Ratio for the values of comparative examples 2 and 3, “0.444 and 0.460

### Examples 9 and 10

### Production of Weld-Cut Sealing/Heat-Shrinkable Packaging Films F9 and F10 Through Tubular Method, and Evaluation of Physical Properties

### Example 9

Into 100 parts by weight of the dried PET pellets “A3” having increased molecular weight and increased melt strength of the present invention (MFR of 8.5 g/10 minutes, IV value of 0.88, Production Example 11), 0.1 part by weight of calcium stearate was added, and the whole was mixed for 2 minutes with a super mixer. Next, a double bubble tubular method was performed. The mixture was extruded downward by using a single-screw extruder having a diameter of 40 mm for a first stage from a die having a diameter of 50 mm at a screw temperature of 270° C. and a resin supply speed of 5 Kg/h, and formed into a tube through a water cooling method. The obtained tube was carried upward and was subjected to simultaneous biaxial orientation several times in longitudinal and transverse directions at 90 to 100° C. through a downward tubular method for a second stage, to thereby form an oriented film “F9” having a thickness of about 12 μm obtained through the tubular method. Fish eyes were observed in the film “F9”. The PET film “F9” of the present invention as a flat film was weld-cut sealed, held in a hot air furnace at 120° C. for 2 minutes, and then measured for weld-cut sealing strength. The PET film “F9” had a weld-cut sealing strength of 0.46 Kg/15 mm width and had substantially the same weld-cut sealing strength after 2 weeks. The films of the present invention each had an “entanglement effect” of molecular chains derived from a long chain branched structure, and thus had hardly any changes in physical properties of the film over time.

### Example 10

Similarly, the PET/PETG/polyester elastomer block copolymer pellets “C1” (composition ratio: 100/30/5, MFR of 6.4 g/10 minutes) having increased molecular weight and increased melt strength of the present invention were molded into a film through a double bubble tubular method (F10, thickness of about 12 μm). This block copolymer allowed simultaneous biaxial orientation at a relatively low temperature, and thus a biaxial orientation temperature through a downward tubular method for the second stage was set to 85 to 95° C. A mixing property improving effect of a special single-screw prevented a localized reaction among the binders, catalyst, and resin, and allowed the resin to be filled inside the screw. Thus, dark brown scorching was prevented, and formation of fish eyes in the film “F10” was remarkably reduced. The obtained PET film F10 of the present invention was weld-cut sealed in a flat film, held in a hot air furnace at 120° C. for 2 minutes, and then measured for weld-cut sealing strength. The PET film “F10” had a weld-cutsealing strength of 1.1 Kg/15 mm width and a degree of heat-shrinkage of 45%, and had substantially the same values after 2 weeks. The results indicated that the film “F10” of the present invention had sufficient physical properties for practical use.

### Examples 11 to 14

### Production of PET Film “S1138, PET/Polyester Elastomer Copolymer Film “S12”, and PET/PETG/Polyester Elastomer Copolymer Films “S13” and “S14” Through Casting Method, Modification of Films “S11 to “S14” into Biaxially Oriented Films “F11” to “F14”, and Heat-Shrinkable Packaging

[Production of Film “S11” Through casting Method]

A mixture of 100 parts by weight of dried pale blue PET pellets prepared through a polycondensation method (main raw material a: fiber grade fresh product, IV of 0.61 dl/g, MFR of 85 g/10 minutes at 280° C., zero shear melt viscosity of 150 Pa·s at 280° C., carboxylic acid value of 30 meq/kg) available from TUNTEX (Taiwan), 2 parts by weight (effective amount of 0.26 part by weight) of transparent mini pellets as a binder masterbatch i6 (produced in the same manner as in Production Example 4 by using ethylene glycol diglycidyl ether as the binder d and trimethylolpropane triglycidyl ether as the binder e and changing e/d to 6.25/93.75), 0.30 part by weight of the powdered composite catalyst masterbatch “k1” (Production Example 6: Li/Na/Ca=25/25/50), 0.1 part by weight of IRGANOX B225 powder as an antioxidant/color protection agent, and 0.15 part by weight of liquid paraffin as a spreader for the powder were mixed with a super mixer for 2 minutes. The obtained mixture was stored in a similar moisture-proof bag.

This mixture was extruded by using a co-rotation twin-screw extruder manufactured by Hitachi Zosen Corporation (screw diameter of 80 mmΦ, L/D=36, two vent-type) at a cylinder set temperature of 260 to 280° C., a degree of vacuum of the first and second vents of 0.3 KPa or less, a screw rotation speed of 100 rpm, and a mixture supply speed of 200 Kg/h. The mixture was extruded with a T-die of 1,400 mm in width at 265° C. and allowed to pass between chilled rolls at 30 to 60° C. through a casting method, to thereby produce about 300 m of a PET film “S11” (composition ratio: 100) having increased molecular weight and increased melt strength and having a thickness of 0.22 mm and a slit width of 1,040 mm.

[Production of Film S12 Through Casting Method]

About 300 m of a PET/polyester elastomer block copolymer film “S12” (composition ratio: 100/5) having increased molecular weight and increased melt strength and having a thickness of 0.22 mm and a slit width of 1,040 mm was produced through a casting method in the same manner as in the above Example 11, except that 5 parts by weight of dried brown pellets of a polyester elastomer Nouvelan 4400 series (auxiliary material c: novel polyester-type TRB-ELA, MFR of about 40 g/10 minutes at 230° C.) available from Teijin Ltd. was additionally used.

[Production of Film “S13” Through Casting Method]

About 300 m of a PET/PETG/polyester elastomer block copolymer film “S13” (composition ratio: 100/66/5) having increased molecular weight and increased melt strength and having a thickness of 0.22 mm and a slit width of 1,040 mm was produced through a casting method in the same manner as in the above Example 11, except that 5 parts by weight of dried brown pellets of a polyester elastomer Nouvelan 4400 series available from Teijin Ltd., and 66 parts by weight of dried transparent pellets PETG 6763 (auxiliary material “b”: fresh pellets, IV of 0.73 dl/g, MFR of 120 g/10 minutes at 280° C., Mn of 26,000) available from Eastman Chemical Company were additionally used.

[Production of Film “S14” Through Casting Method]

About 300 m of a PET/PETG/polyester elastomer block copolymer film “S14” (composition ratio: 100/150/5) having increased molecular weight and increased melt strength and having a thickness of 0.22 mm and a slit width of 1,040 mm was produced through a casting method in the same manner as in the above Example 11, except that 5 parts by weight of dried brown pellets of a polyester elastomer Nouvelan 4400 series available from Teijin Ltd., and 150 parts by weight of PETG available from Eastman Chemical Company were additionally used.

[Modification of Films “S11” to “S14” into Biaxially Oriented Films “F11” to “F14”, and Evaluation of Heat-Shrinkage Property and Weld-Cut Sealing Property]

The films each having a thickness of 0.22 mm and obtained through a casting method, that is, the PET film “S11” (composition ratio: 100), the PET/polyester elastomer block copolymer film “S12” (composition ratio: 100/5), the PET/PETG/polyester elastomer block copolymer films “S13” (composition ratio: 100/66/5) and “S14” (composition ratio: 100/150/5) were each cut into a sample of 14 cm square. As Comparative Example H13, the PETG film having a thickness of 0.20 mm and obtained through a casting method was also cut into samples 14 cm square.

From the small pieces of 14 cm square each, biaxially oriented films “F11” to “F14” were produced through simultaneous longitudinal and transverse biaxial orientation by using a biaxial orientation test apparatus manufactured by Iwamoto Seisakusho Co., under the conditions such as a film surface set temperature of 80 to 105° C., a chuck interval of 13 cm, and a chuck speed of 20 to 50 mm/seconds. The films F11 to F14 of the present invention as flat films were each measured for a degree of heat-shrinkage at 90 to 120° C. for 2 minutes by using a hot air furnace. Table 4 shows the results of the degree of heat-shrinkage measurement together with the results of PETG of Comparative Example H3.

TABLE 4
Simultaneously biaxially oriented film obtained from small 4 cm × 4 cm pieces,
and degree of heat-shrinkage

| | Cast/biaxially | Simultaneous biaxial | | | | | |
|---|---|---|---|---|---|---|---|
| | oriented film No. | orientation (4 × 4 times) | | | Degree of heat-shrinkage | | |
| | [Raw material | | | Product | (hot air furnace) | | |
| | composition: PET/ | Temperature | Orientation | thickness | 90 (° C.) | 100 (° C.) | 120 (° C.) |
| Example | PETG/elastomer] | (° C.) | workabilty | (μm) | (%) | (%) | (%) |
| 11 | S11/F11 | 80 | Cannot be molded | — | — | — | — |
| | [100/0/0] | 85 | Cannot be molded | — | — | — | — |
| | | 90 | Cannot be molded | — | — | — | — |
| | | 95 | Good | 18 | 13 | 18 | 22 |
| | | 105 | Good | 18 | 8 | 16 | 16 |
| 12 | S12/F12 | 80 | Cannot be molded | — | — | — | — |
| | [100/0/5] | 85 | Good | 16 | 15 | 19 | 23 |
| | | 90 | Good | 16 | 9 | 13 | 17 |
| | | 95 | Good | 16 | 4 | 5 | 9 |
| 13 | S13/F13 | 80 | Cannot be molded | — | — | — | — |
| | [100/66/5] | 85 | Good | 21 | 29 | 33 | 37 |
| | | 90 | Good | 21 | 19 | 26 | 27 |
| | | 95 | Good | 21 | 10 | 12 | 18 |
| 14 | S14/F14 | 80 | Good | 18 | 45 | 50 | 51 |
| | [100/150/5] | 85 | Good | 18 | 31 | 34 | 38 |
| | | 90 | Good | 18 | 23 | 25 | 30 |
| | | 95 | Good | 18 | 14 | 7 | 21 |
| Comparative | H3/HF3 | 80 | Cannot be molded | — | — | — | — |
| example 3 | [0/100/0] | 85 | Cannot be molded | — | — | — | — |
| | | 90 | Good | 16 | 33 | 49 | 73 |
| | | 95 | Good | 16 | 26 | 40 | 53 |

As in Example 11, of the film “S11” containing PET alone as the main raw material “a” obtained through a casting method was not possible to be subjected to low temperature orientation at 80 to 90° C. Thus, the biaxially oriented film “F11” obtained from the film “S11” had a low degree of heat-shrinkage of 8 to 22% at 90 to 120° C. The film “F11” had gloss, and good transparency, and was rigid. Thus, the film “F11” was most appropriate for light-gage packaging of magazines and the like but was inappropriate for heavy-gage packaging.

As in Example 12, orientation molding property of the film “F12” containing 5 parts of a polyester elastomer as the auxiliary material c improved significantly as that of the film “S12” obtained through a casting method, and low temperature orientation of the film F12 was possible at 85° C., in particular. Thus, the biaxially oriented film “F12” obtained from the film S12 had a slightly improved degree of heat-shrinkage at 90 to 120° C. The film “F12” had gloss, and better transparency, was flexible, and had doubled weld-cut sealing strength. Thus, the film “F12” was appropriate for light-gage packaging of magazines, thin containers, and the like but was still inappropriate for heavy-gage packaging.

As in Example 13, orientation molding property of the film “F13” containing 66 parts of PETG as the auxiliary material “b” and 5 parts of a polyester elastomer as the auxiliary material “c” improved more significantly as that of the film “S13” obtained through a casting method, and low temperature orientation of the film “F13” at 85° C. was possible. The biaxially oriented film “F13” obtained from the film “S13” had a significantly improved degree of heat-shrinkage of 10% or more at 90 to 120° C. The film “F13” had gloss, had even better transparency, was flexible, and had a sufficient weld-cut sealing strength of 0.7 to 1 kg/15 mm. Thus, the film “F13” was appropriate for general packaging.

As in Example 14, low temperature orientation of the film “F14” containing 150 parts of PETG(doubled) as the auxiliary material “b” and 5 parts of a polyester elastomer as the auxiliary material “c” was possible at 80° C. as that of the film “S14” obtained through a casting method, in particular. Thus, owing to low temperature orientation, the biaxially oriented film F14 obtained from the film “S14” had a degree of heat-shrinkage improved by 20% or more, and a maximum degree of heat-shrinkage of 51% at 90 to 120° C. The film “F14” had gloss, even better transparency, was flexible, and had a substantially sufficient weld-cut sealing strength of 0.6 to 0.8 kg/15 mm. Thus, the film “F14” was appropriate for specific packaging for low temperature applications. However, PETG is an amorphous resin having a glass transition temperature (Tg) of 81° C., and thus the film “F14” preferably has 100 parts or less of PETG with respect to 100 parts of PET for general packaging requiring heat resistance of 80° C. or higher.

Orientation molding of the PETG film “H3” obtained through a casting method of Comparative Example 3 was not possible at 80 to 85° C. However, the biaxially oriented film (FH3) obtained through high temperature molding had a maximum degree of heat-shrinkage of 73% and a greatly fluctuating weld-cut sealing strength of 0.4 to 1 kg/15 mm. In particular, the weld-cut sealing strength reduced significantly after 2 weeks at 35° C. in the summer.

### Examples 15 and 16

### Modification of PET/PETG/Polyester Elastomer Copolymer Films “S13” and “S14” Obtained Through Casting Method into Continuously Biaxially Oriented Films “F15” and “F16”, and Heat-Shrinkable Packaging

The film “S13” (composition ratio of PET/PETG/polyester elastomer: 100/66/5) and film “S14” (composition ratio thereof: 100/150/5) produced in Examples 13 and 14 and each having a thickness of 0.22 mm and obtained through a casting method were each formed into a roll of 260 mm width×250 m length.

A continuous biaxial orientation test was performed by using a small biaxial orientation producing apparatus in accordance with the results of a batch biaxial orientation molding test of the small pieces of 14 cm square each. The films “S13” and “S14” each having a width of 260 mm were supplied continuously from an apparatus inlet, to thereby produce biaxially oriented films “F15” and “F16” each having a thickness of 13 to 18 μm and a slit width of 400 to 500 mm under the conditions such as an inlet chuck interval of 225 mm, an inlet speed of 0.5 m/minute, a hot air temperature of 80 to 100° C., preheating of 350 mm in length/orientation of 775 mm in length/three-stage heat-setting of 1,500 mm in length, and simultaneous biaxial orientation of 3.5×3.5 to 4×4.

Table 5 shows the results of the production tests. The continuously biaxially oriented films “F15” and “F16” of Examples 15 and 16 had very different molding workability from molding workability of the small pieces of the batch biaxially oriented films in Examples 13 and 14 even through the same film obtained through a casting method was used. The continuously biaxially oriented films generally had a higher orienting temperature by 10° C. than that of the batch biaxially oriented films. Of the continuously biaxially oriented films, contrary to the batch biaxially oriented films, the film “S13” (composition ratio of PET/PETG/polyester elastomer: 100/66/5) had much better molding workability than that of the film “S14” (composition ratio thereof: 100/150/5). Thus, a mixing ratio of PETG is preferably 40 to 70 parts by weight.

TABLE 5
Table 5: Production of continuously and simultaneously biaxially oriented film

| | Cast/biaxially | | | | | | | |
|---|---|---|---|---|---|---|---|---|
| | oriented film | | | | | | | |
| | No. | | | | | | | Molding |
| | [Raw material | | Temperature conditions | | | | | property |
| | composition: | | | Biaxial | | | | of |
| | PET/PETG/ | Orientation | Preheating | Orientation | Heat-setting 1 | Heat-setting 2 | Heat-setting 3 | oriented |
| Example | elastomer] | ratio | (° C.) | (° C.) | (° C.) | (° C.) | (° C.) | film |
| 15 | S13/F15 | 4 × 4 | 85 | 85 | 80 | 80 | 80 | Intermittent |
| | [100/66/5] | | | | | | | breakage |
| | | 4 × 4 | 95 | 95 | 90 | 90 | 90 | Good, |
| | | | | | | | | leader |
| | | | | | | | | mark |
| | | 4 × 4 | 95 | 95 | 80 | 80 | 80 | Good |
| | | 3.5 × 3.5 | 95 | 95 | 80 | 80 | 80 | Excellent |
| 16 | S14/F16 | 4 × 4 | 95 | 95 | 80 | 80 | 80 | Intermittent |
| | [100/150/5] | | | | | | | breakage |
| | | 3.5 × 3.5 | 90 | 90 | 80 | 80 | 80 | Good |

The thus-obtained biaxially oriented films “F15” and “F16” as flat films each had a degree of heat-shrinkage of 40 to 60% at 120° C. for 2 minutes and a large weld-cut sealing strength of 0.7 to 1.2 kg/15 mm. In particular, the biaxially oriented films “F15” and “F16” each had a sufficiently maintained weld-cut sealing strength after 2 weeks at 35° C.

### Example 17

### Production of PET/PETG/Polyester Elastomer Block Copolymer Pellets “C2” Without Gel/Fish Eye in Reaction Chamber for High Viscosity, and Production of Biaxially Oriented Film Through Tubular Method

Into a reaction chamber for high viscosity (volume of 1 m³, heat medium heating-type, helical stirring blade, high power stirrer equipped with a torque meter, provided with a gear pump at a lower part, vacuum line, and the like), 200 Kg of dried pale blue PET pellets prepared through a polycondensation method (main raw material a) available from TUNTEX (Taiwan) were introduced, and were melted at 270° C. in a nitrogen atmosphere. Then, 80 Kg of dried transparent pellets of PETG 6763 (auxiliary material b) available from Eastman Chemical Company, and 10 Kg of dried brown pellets of a polyester elastomer Nouvelan 4400 series (auxiliary material c) available from Teijin, Ltd. were additionally introduced there into, and the whole was mixed uniformly under deaeration and dehydration in high vacuum. Next, 0.30 Kg of the powdered composite catalyst masterbatch “k1” (Production Example 6: Li/Na/Ca=25/25/50), 0.10 Kg of IRGANOX B225 powder as an antioxidant/color protection agent, 0.15 Kg of phosphorous acid as a stabilizer, and 20 Kg (effective amount of 1.32 parts by weight, e/d=25/75) of transparent mini pellets as the binder masterbatch “i2” were additionally introduced into the mixture in a nitrogen atmosphere. The whole was stirred at high speed at 100 rpm or more for 10 to 30 minutes, to there by form a uniform reaction system. This formation of a uniform reaction system prevented formation of gel/fish eye as a by-product. Formation of a block copolymer caused rapid viscosity increase. Thus, the stirring was stopped so as to prevent over torque, and the mixture was maintained at 270° C. for an additional 2 hours. A nitrogen pressure was applied to the reaction chamber, and twenty strands of a soft glutinous product were extruded downward into water from a die having circumferentially arranged strand ports by driving a gear pump provided on a lower part of the reaction chamber. The strands were cooled with water, and were formed into cylindrical pellets by cutting the strands with a rotational cutter. The obtained pellets were dried with hot air at 130° C. for about 3 hours, and the resultant was stored in a moisture-proof bags as described above. The thus-obtained PET/PETG/PES elastomer block copolymer pellets “C2” (composition ratio: 100/40/5) of the present invention had an MFR of 3.2 g/10 minutes, and were obtained in an yield of about 250 Kg.

The obtained block copolymer pellets “C2” (composition ratio: 100/40/5, MFR of 3.2 g/10 minutes) of the present invention were formed into a film (F17, thickness of about 12 μm) through a double bubble tubular method in the same manner as in Example 9. This block copolymer allowed simultaneous biaxial orientation at a relatively low temperature, and thus a biaxial orientation temperature through a downward tubular method for the second stage was set to 85 to 95° C. A mixing property improving effect owing to the presence of the stabilizer in the reaction chamber prevented a localized reaction among the binders, catalyst, and resin, and no formation of gel/fish eye was observed in the obtained film. The block copolymer film “F17” of the present invention had a weld-cut sealing strength of about 1.0 Kg/15 mm width and a degree of heat-shrinkage of about 48%, and had substantially the same values after 2 weeks. The results indicated that the film “F17” of the present invention had sufficient physical properties for practical use.

1. A method of producing a weld-cut sealing/heat-shrinkable packaging film formed of a PET-based block copolymer polyester, characterized by comprising:
melting at a temperature of 250° C. or above a mixture “A” comprising:
(1) 100 parts by weight of a polyethylene terephthalate (PET)-based polyester “a” having a melt flow rate (MFR, JIS method: 280° C., load of 2.16 Kg) of 45 to 130 g/10 minutes as a main raw material;
(2) 10 to 100 parts by weight of an ethylene glycol/cyclohexane dimethanol/phthalic acid copolyester “b” as an auxiliary material;
(3) 2 to 20 parts by weight of a polyester elastomer “c” as another auxiliary material;
(4) 0.1 to 2 parts by weight of a mixture “f” containing a compound “d” having two epoxy groups and a compound “e” having three or more epoxy groups in a weight ratio of (95 to 40)/(5 to 60) as a binder; and
(5) 0.05 to 1 part by weight of an organic acid metal salt “g” as a catalyst;
turning the mixture “A” into block copolymer pellets by subjecting it to a uniform reaction under deaeration and dehydration in vacuum;
molding a mixture comprising 100 to 10 parts by weight of the block copolymer pellets and 0 to 90 parts by weight of PET “B” having an intrinsic viscosity of 0.60 to 0.80 dL/g into an unoriented film through a casting method; and
extending the unoriented film into an oriented film through a biaxial orientation method.

2. A method of producing a weld-cut sealing/heat-shrinkable packaging film formed of a PET-based block copolymer polyester, characterized by comprising:
melting at a temperature of 250° C. or above a mixture “A” comprising:
(1) 100 parts by weight of a PET-based polyester “a” having an MFR (JIS method: 280° C., load of 2.16 Kg) of 45 to 130 g/10 minutes as a main raw material;
(2) 10 to 100 parts by weight of an ethylene glycol/cyclohexane dimethanol/phthalic acid copolyester “b” as an auxiliary material;
(3) 2 to 20 parts by weight of a polyester elastomer “c” as another auxiliary material;
(4) 0.1 to 2 parts by weight of a mixture “f” containing a compound “d” having two epoxy groups and a compound “e” having three or more epoxy groups in a weight ratio of (95 to 40)/(5 to 60) as a binder; and
(5) 0.05 to 1 part by weight of an organic acid metal salt “g” as a catalyst;
turning the mixture “A” into block copolymer by subjecting it to a uniform reaction under deaeration and dehydration in vacuum;
molding the obtained block copolymer into an unoriented film through a casting method; and
extending the unoriented film into an oriented film through a biaxial orientation method.

3. A method of producing a weld-cut sealing/heat-shrinkable packaging film formed of a PET-based block copolymer polyester, characterized by comprising:
melting at a temperature of 250° C. or above a mixture “A” comprising:
(1) 100 parts by weight of a PET-based polyester “a” having an MFR (JIS method: 280° C., load of 2.16 Kg) of 45 to 130 g/10 minutes as a main raw material;
(2) 10 to 100 parts by weight of an ethylene glycol/cyclohexane dimethanol/phthalic acid copolyester “b” as an auxiliary material;
(3) 2 to 20 parts by weight of a polyester elastomer “c” as another auxiliary material;
(4) 0.1 to 2 parts by weight of a mixture “f” containing a compound “d” having two epoxy groups and a compound “e” having three or more epoxy groups in a weight ratio of (95 to 40)/(5 to 60) as a binder; and
(5) 0.05 to 1 part by weight of an organic acid metal salt “g” as a catalyst;
turning the mixture “A” into block copolymer by subjecting it to a uniform reaction under deaeration and dehydration in vacuum;
extruding the block copolymer into a cast film;
while continuously extending the cast film into an oriented film through a biaxial orientation method.

4. A method of producing a weld-cut sealing/heat-shrinkable packaging film formed of a PET-based block copolymer polyester according to claim 1, characterized in that a temperature for extending the film into the oriented film through a biaxial orientation method is 80 to 100° C.

5. A method of producing a weld-cut sealing/heat-shrinkable packaging film formed of a PET-based block copolymer polyester, characterized in that the weld-cut sealing/heat-shrinkable packaging film formed of a PET-based block copolymer polyester to be produced through the method according to claim 1 has a degree of heat-shrinkage of 30% or more at 130° C.

6. A method of producing a weld-cut sealing/heat-shrinkable packaging film formed of a PET-based block copolymer polyester, characterized in that the weld-cut sealing/heat-shrinkable packaging film formed of a PET-based block copolymer polyester to be produced through the method according to claim 1 has a weld-cut sealing strength of 500 g/15 mm width or more.

7. A method of producing a weld-cut sealing/heat-shrinkable packaging film formed of a PET-based block copolymer polyester according to claim 1, characterized in that the PET-based polyester “a” comprises at least one selected from the group consisting of PET having an intrinsic viscosity of 0.60 to 0.80 dl/g, and a recycled product of a PET-based aromatic polyester molded product.

8. A method of producing a weld-cut sealing/heat-shrinkable packaging film formed of a PET-based block copolymer polyester according to claim 1, characterized in that the compound “d” comprises at least one selected from the group consisting of: aliphatic ethylene glycol diglycidyl ether, polyethylene glycol diglycidyl ether, and hexamethylene diglycidyl ether; alicyclic hydrogenated bisphenol A diglycidyl ether; and aromatic bisphenol A diglycidyl ether.

9. A method of producing a weld-cut sealing/heat-shrinkable packaging film formed of a PET-based block copolymer polyester according to to claim 1, characterized in that the compound “e” comprises at least one selected from the group consisting of: aliphatic trimethylolpropane triglycidyl ether, glycerin triglycidyl ether, epoxidized soybean oil, and epoxidized linseed oil; heterocyclic triglycidyl isocyanurate; and aromatic phenol novolac epoxy resin and cresol novolac epoxy resin.

10. A method of producing a weld-cut sealing/heat-shrinkable packaging film formed of a PET-based block copolymer polyester according to claim 1, characterized in that the coupling reaction catalyst “g” comprises a composite containing at least two kinds of salts selected from lithium salt, sodium salt, potassium salt, magnesium salt, calcium salt, zinc salt, and manganese salt of one of stearic acid and acetic acid.

11. A method of producing a weld-cut sealing/heat-shrinkable packaging film formed of a PET-based block copolymer polyester, characterized by comprising:
melting at a temperature of 250° C. or above a mixture A′ comprising:
(1) 100 parts by weight of a PET-based polyester “a” having an MFR (JIS method: 280° C., load of 2.16 Kg) of 45 to 130 g/10 minutes as a main raw material;
(2) 10 to 100 parts by weight of an ethylene glycol/cyclohexane dimethanol/phthalic acid copolyester “b” as an auxiliary material;
(3) 2 to 20 parts by weight of a polyester elastomer “c” as another auxiliary material;
(4) 1 to 15 parts by weight of a binder masterbatch “i” comprising 100 to 50 parts by weight of a mixture “f” containing a compound “d” having two epoxy groups and a compound “e” having three or more epoxy groups in a weight ratio of (95 to 40)/(5 to 60), and 100 parts by weight of a base substance “h” as a binder; and
(5) 0.5 to 5 parts by weight of a catalyst masterbatch “k” containing 5 to 15 parts by weight of an organic acid metal salt “g” and 100 parts by weight of a base substance “j” as a catalyst;
turning the mixture A′ into a block copolymer by subjecting it to a uniform reaction under deaeration and dehydration in vacuum; and
molding the obtained block copolymer into an oriented film through a biaxial orientation method or a tubular method.
